(19) United States
(12) Patent Application Publication
(10) Pub. No.: US 2003/0130398 A1
(43) Pub. Date: Jul. 10, 2003

(54) Soft polymeric compounds including metal oxide fillers

(75) Inventor: Xiaorong Wang, Hudson, OH (US)

Correspondence Address: Chief Intellectual Property Counsel, Bridgestone/Firestone, Inc., 1200 Firestone Parkway, Akron, OH, 44317-0001, US

(73) Assignee: Bridgestone Corporation

(21) Appl. No.: 10/039,115

(22) Filed: Dec. 31, 2001

(51) Int. Cl. C08L 1/00

(52) U.S. Cl. 524/430

(57) ABSTRACT

The present invention is a thermoreversible polymeric gel composition including a polymer having at least one maleimide monomer unit and at least one other monomer unit selected from a vinyl-substituted aromatic hydrocarbon, a R¹R²ethylene, and/or an alkyl vinyl ether; a metal oxide filler; a maleated polyalkylene; and an extender The metal oxide filler improves the tensile strength, tear strength, damping properties, high-temperature compression set, and electric sensitivity of the copolymers. The Shore A hardness of the present polymer gel compositions at room temperature is preferably less than about 30. The present polymer gel compositions preferably has a service temperature up to about 145° C.

### BACKGROUND

The present invention relates to high damping polymer compositions with desirable high-temperature stability, mechanical strength, and moldability.

Free radical copolymerization of vinyl-substituted aromatic hydrocarbons and butadiene, vinyl-substituted aromatic hydrocarbons and maleic anhydride, R¹R²ethylenes and maleic anhydride, and alkyl vinyl ethers and maleic anhydride are known. Further, imidization between a maleic anhydride and a mono-primary amine group is a recognized chemical reaction

Copolymers such as those described above have been used in a variety of applications. These copolymers have been further reacted with maleated polyalkylenes. These reactions are often carried out in the presence of a diamine which links the poly(alkenyl-co-maleimide) copolymers to the maleated polyalkylene

In turn, the maleated polyalkylene grafted poly(alkenyl benzene-co-maleimide) polymers described above have been dispersed in rubber formulations Such dispersions lead to the formation of high damping compounds. The rubber formulations demonstrate superior vibration resistance.

Additionally, poly(alkenyl-co-maleimide) polymers have been combined with a non-vulcanized thermoplastic elastomer polymer or copolymer to form high damping gel compositions

Furthermore, fillers have been added to a rubber matrix as mechanical enhancing agents, with applications for increasing strength and modulus of the polymer matrix to be filled. The characteristics which determine the properties a filler imparts to a rubber compound are particle size, surface area, structure, and surface activity In considering fillers of adequately small particle size, reinforcement potential can be predicted from the fillers of surface area, surface activity, and persistent structure or anisometry.

The general influence of each of these three filler characteristics above on rubber properties can be summarized as follows:

1 Increasing surface area (decreasing particle size) gives lower resilience and higher Mooney viscosity, tensile strength, abrasion resistance, tear resistance, and hysteresis.

2 Increasing surface activity (including surface treatment) gives higher abrasion resistance, chemical adsorption or reaction, modulus, and hysteresis.

3 Increasing persistent structure/anisometry gives higher Mooney viscosity, modulus, and hysteresis, lower extrusion shrinkage, tear resistance, and resilience, and longer incorporation time.

In general terms, the effect of a filler on rubber physical properties can be related mainly to how many polymer chains are attached to the filler surface and how strongly they are attached

To achieve general property improvement in a soft polymer gel composition, proper selection of filler is of key importance. Filler-filler interaction should not be so strong as to significantly increase the compound viscosity during mixing or the hardness of the finished product. However, high tensile strength and increased damping properties at elevated temperatures are desired. The filler and the polymer matrix should be compatible enough so that the filler can be incorporated and dispersed into the matrix easily and uniformly while only minimally disturbing the structure of the original polymer composition. Importantly, and as suggested above, fillers work differently in various polymeric systems. In this regard, use of a filler in a polymer gel to provide high damping properties has proven especially difficult Accordingly, identifying a filler that has the correct combination of the above-mentioned properties to promote damping properties in a soft polymer composition is desirable.

### SUMMARY OF THE INVENTION

The present invention is a thermoreversible polymeric gel composition including a polymer having at least one maleimide monomer unit and at least one other monomer unit selected from a vinyl-substituted aromatic hydrocarbon, a R¹R²ethylene, and/or an alkyl vinyl ether; a metal oxide filler, a maleated polyalkylene; and, an extender

The present invention is directed to the use of copolymer gel filled with a metal oxide filler to improve the tensile strength, tear strength, damping properties, high-temperature compression set, and electric sensitivity of these copolymers. The Shore A hardness of the present polymer gel composition at room temperature is less than about 30. The present polymer gel composition most preferably has a service temperature up to about 145° C.

The preferred polymers in the present invention are centipede polymers Centipede polymers are grafted polymer compositions of a maleated polyalkylene and a poly(alkenyl-co-maleimide). The alkenyl group in the centipede polymers can be a vinyl-substituted aromatic hydrocarbon, a R¹R²ethylene, and/or an alkyl vinyl ether The grafted centipede polymer is a thermoplastic, glass-like material that becomes a soft and rubber-like elastomer after being oil-extended.

The following definitions apply hereinthroughout unless a contrary intention is expressly indicated:

“vinyl aromatic hydrocarbon” and “alkenyl benzene” are used interchangeably,

“maleic anhydride” encompasses dicarboxylic acids, including maleic anhydride, which can form a copolymer with an alkenyl benzene, an R¹R²ethylene, or an alkyl vinyl ether, the copolymer having dicarboxylic acid units which are capable of reaction with an amine functional group;

“maleimide” encompasses the reaction product of an amine and the dicarboxylic acids described above;

“R¹R²ethylene” as used herein encompasses compounds of the general formula:

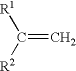

where R¹ and R² are the same or different substituents on the same or different carbon atoms of the ethylene group, and are independently H or substituted C₁-C₂₀ alkyl groups;

“poly(alkenyl-co-maleimide)” includes poly(alkenylbenzene-co-maleimide), poly(R¹R²ethylene-co-maleimide), and poly(alkyl vinyl ether-co-maleimide).

### DETAILED DESCRIPTION OF THE INVENTION

The polymer gel composition utilizing centipede polymers contains about 0 5-200 parts by weight (pbw) of a grafted polymer of a centipede having at least one maleated polyalkylene segment grafted thereto through at least one functional linkage formed by a cross-linking reaction with a grafting agent; optionally, about 0 to 100 pbw extender; and greater than about 0 to about 300 pbw of a metal oxide filler.

The centipede polymer is formed by imidizing a poly(alkenyl-co-maleic anhydride) with a mono-primary amine The centipede polymer has a high molecular weight spine connected with many relatively short side chains formed form the addition of the primary amines. The length of the main chain usually equals or is longer than the entanglement length, which is herein defined theoretically as an order of magnitude of 100 repeating units, while the length of the side chains is much less than the entanglement length

Preferred alkenyl benzene contributed monomer units of the poly(alkenyl benzene-co-maleimide) centipede preferably are derived from one or more of styrene, α-methylstyrene, 1-vinyl-naphthalene, 2-vinyl-naphthalene, 1-α-methyl vinyl naphthalene, 2-α-methyl vinyl naphthalene, as well as alkyl, cycloalkyl, aryl, alkaryl, and aralkyl derivatives thereof, in which the total number of carbon atoms in the combined hydrocarbon is generally not greater than 18, as well as any di-or tri-vinyl aromatic hydrocarbons. Preferred vinyl aromatic hydrocarbons are either styrene or α-methyl styrene.

Preferred R¹R²ethylene contributed monomer units of the poly(R¹R²ethylene-co-maleimide) include any alkene such as ethylene, propylene, butylene, isobutylene, pentene, hexene, heptene, etc., as well as any di- or tri-alkene, or mixtures thereof, with preference given to isobutylene.

Preferred alkyl vinyl ether contributed monomer units of the poly(alkyl vinyl ether-co-maleimide) include any alkylvinyl ether such as methyl vinyl ether, ethyl vinyl ether, propyl vinyl ether, butyl vinyl ether, and any other alkyl vinyl ether wherein the number of carbons in the alkyl substituent is not greater than about 20, and mixtures thereof. A preferred alkyl vinyl ether is methyl vinyl ether

Examples of unsubstituted and substituted alkyl groups R¹, R², and alkyl from the alkyl vinyl ether contributed units are independently substituted or unsubstituted alkyl groups containing 1 to about 20 carbons such as methyl, ethyl, propyl, isopropyl, butyl, isobutyl, pentyl, isopentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, cyclopropyl, 2,2-dimethylcyclopropyl, cyclopentyl, cyclohexyl, methoxymethyl, methoxypropyl, methoxybutyl, methoxypentyl, methoxyhexyl, methoxyheptyl, methoxyoctyl, methoxynonyl, methoxydecyl, ethoxymethyl, ethoxyethyl, ethoxypropyl, ethoxybutyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyhexyl, propoxyheptyl, propoxyoctyl, propoxynonyl, propoxydecyl, butoxybutoxymethyl, butoxyethyl, butoxypropyl, butoxybutyl, butoxypentyl, butoxyhexyl, butoxyheptyl, butoxyoctyl, butoxynonyl, butoxydecyl, pentyloxymethyl, pentyloxyethyl, pentyloxpropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxynonyl, octyloxyoctyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methythexyl, 1-methylheptyl, 1-methyloctyl, 1-methylnonyl, 1-methyldecyl, 2-methylpropyl, 2-methylbutyl, 2-methylpentyl, 2-methylhexyl, 2-methylheptyl, 2-methyloctyl, 2,3-dimethylbutyl, 2,3,3-trimethylbutyl, 3-methylpentyl, 2,3-dimethylpentyl, 2,4-dimethylpentyl, 2,3,3,4-tetramethylpentyl, 3-methylhexyl, 2,5-dimethylhexyl, and the like

The poly(alkenyl-co-maleimides) described herein are subsequently graft-reacted through a difunctional linking or grafting agent to a maleated polyalkylene to yield a maleated polymer having at least one polyalkylene segment grafted thereto through at least one functional linkage thus formed. The alkylene moiety of the polyalkylene can be ethylene and/or propylene A preferred polyalkylene is polypropylene.

The maleated polyalkylene may be any of the conventionally known polyalkylene compounds that can be subsequently maleated by methods known in the art. The polyalkylene grafted segment or segments have weight average molecular weights (M_{w}) of about 1000 to about 10,000,000 or higher, preferably about 20,000 to about 300,000

The crystallinity of the polyalkylene may vary from being substantially amorphous to being completely crystalline, that is from about 10-100% crystallinity Most typically, because of the extensive commercial use of isotactic polypropylene, the grafted polypropylene will be substantially crystalline, e.g., having a crystallinity (greater than about 90% Generally, the polypropylene is substantially free of ethylene. However, under certain circumstances, small amounts of ethylene, on the order of less than about 10% by weight, may be incorporated. Furthermore, in certain instances, the polypropylene contains small amounts of ethylene in copolymers known as “reactor copolymers” Thus, the grafted polypropylenes can contain minor amounts of ethylene, both as part of the ethylene-propylene segments and as polyethylene segments.

The maleated polyalkylene contains from about 0.01 wt % incorporated maleic anhydride, based upon the weight of the maleated polyalkylene, up to about 5 wt %. Preferably, the maleic anhydride content will be from about 0 01 to about 2 wt %, most preferably about 0.03 to about 0.2 wt %. As will be apparent, unreacted polyalkylene is present in the reaction mix as are minor amounts of reaction by-products, such as decomposed free-radical initiator compounds and low molecular weight free-radical products. These by-products are substantially removed by methods known in the art, e.g., sparging with N₂ or washing with water. Maleic anhydride may not be left in substantial amounts in the polymer without detrimental effects on the subsequent reaction of the poly(alkenyl-co-maleimide) with the maleated polyalkylene.

The poly(alkenyl-co-maleimide) is formed by reacting a poly(alkenyl-co-maleic anhydride) in the presence of a mono-primary amine at temperatures from about 100° C. to about 300° C. and at a pressure from about slightly above vacuum to about 2026 kPa, under substantially dry conditions. The reactants are preferably dry mixed in the absence of solvents in a suitable mixing apparatus such as a Brabender mixer. Purging the mixer with Nz prior to charging of the reactants can be preferred. The primary amine or ammonia may be added in a single charge, or in sequential partial charges into the reactor containing a charge of poly(alkenyl-co-maleic anhydride). Preferably, the primary amine is charged in ratio between 0.8 to 1 0 moles of nitrogen per monomer contributed units of maleic anhydride in the poly(alkenyl-co-maleic anhydride).

Suitable primary amines include, but are not limited to alkyl amines; alkyl benzyl amines, alkyl phenyl amines, alkoxybenzyl amines, allyl aminobenzoates, alkoxy aniline, and other linear primary amines containing from 1 to 50 carbon atoms, preferably 6 to 30 carbon atoms in the alkyl and alkoxy substituents in these primary amines. The alkyl and alkoxy substituents on the above-discussed primary amines can be linear or branched, preferably linear, and saturated or unsaturated, preferably saturated Exemplary amines include hexylamine, octylamine, dodecylamine, and the like.

The poly(alkenyl-co-maleimide) prior to grafting with maleated polyalkylene, preferably has a M_{w} between about 10,000 and 500,000, more typically between about 150,000 and 450,000.

The centipede polymer may be prepared by any means known in the art for combining such ingredients, such as blending, milling, or internal batch mixing A rapid and convenient method of preparation involves heating a mixture of components to a temperature of about 50° to 290° C.

The centipede polymers of this invention are preferably manufactured by mixing and dynamically heat-treating the components described above, namely, by melt-mixing As for the mixing equipment, any conventional, generally known equipment such as an open-type mixing roll, closed-type Banbury mixer, closed-type Brabender mixer, extruding machine, kneader, continuous mixer, etc., is acceptable. The closed-type Brabender mixer is preferred, as is mixing in an inactive gas environment such as N₂ or Ar.

Grafting of the maleated polyalkylene and the poly(alkenyl-co-maleimide) is performed by adding a grafting agent to the reaction mixture. Preferred grafting agents include low molecular weight organic compounds with at least 2 functional groups capable of crosslinking said polymer. Appropriate functional groups include primary amine, secondary amine, carboxyl, formyl, and hydroxyl A preferred grafting agent is a polyamine, preferably an organic diamine The grafting agent is added to a blend of maleated polyalkylene and poly(alkenyl-co-maleimide) to partially cross-link the polyalkylene to the poly(alkenyl-co-maleimide) through the maleate functional groups.

Suitable organic diamines or diamine mixtures containing two aliphatically or cycloaliphatically bound primary amino groups are used as grafting agents for the process according to the present invention. Such diamines include, for example, aliphatic or cycloaliphatic diamines corresponding to the formula R³(NH₂)₂, wherein R³ represents a C₂-C₂₀ aliphatic hydrocarbon group, a C₄-C₂₀ cycloaliphatic hydrocarbon group, a C₆-C₂₀ aromatic hydrocarbon group, or a C₄-C₂₀ N-heterocyclic ring, e g., ethylenediamine; 1,2- and 1,3-propylene diamine, 1,4-diaminobutane, 2,2-dimethyl-1,3-diaminopropane, 1,6-diaminohexane, 2,5-dimethyl-2,5-diaminohexane, 1,6-diaminoundecane; 1,12-diaminododecane; 1-methyl-4-(aminoisopropyl)-cyclohexylamine; 3-aminomethyl-3,5,5-trimethyl-cyclohexylamine; 1,2-bis-(aminomethyl)-cyclobutane, 1,2-diamino-3,6-dimethylbenzene, 1,2- and 1,4-diaminocyclohexane; 1,2-, 1,4-, 1,5-, and 1,8-diaminodecalin, 1-methyl-4-aminoisopropyl-cyclohexylamine; 4,4′-diamino-dicyclohexyl methane; 2,2′-(bis-4-amino-cyclohexyl)-propane; 3,3′-dimethyl-4,4′-diaminodicyclohexyl methane; 1,2-bis-(4-aminocyclohexyl)-ethane; 3,3′,5,5′-tetramethyl-bis-(4-aminocyclohexyl)-methane and -propane; 1,4-bis-(2-aminoethyl)-benzene; benzidine, 4,4′-thiodianiline, 3,3′-dimethoxybenzidine, 2,4-diaminotoluene, diaminoditolylsulfone, 2,6-diaminopyridine; 4-methoxy-6-methyl-m-phenylenediamine, diaminodiphenyl ether; 4,4′-bis(o-toluidine), o-phenylenediamine, methylene bis(o-chloroaniline), bis(3,4-diaminophenyl) sulfone; diamino-phenylsulfone; 4-chloro-o-phenylenediamine; m-aminobenzyl amine; m-phenylene diamine; 4,4′-C₁-C₆-dianiline; 4,4′-methylene-dianiline, aniline-formaldehyde resin, trimethylene glycol-di-p-aminobenzoate, bis-(2-aminoethyl)-amine, bis-(3-aminopropyl) amine; bis-(4-aminobutyl)-amine, bis-(6-aminohexyl)-amine, and isomeric mixtures of dipropylene triamine and dibutylene triamine. Mixtures of these diamines may also be used.

Other suitable polyamines for use as grafting agents include bis-(aminoalkyl)-amines, preferably those having a total of from 4 to 12 carbon atoms such as bis-(2-aminoethyl) amine, bis-(3-aminopropyl) amine, bis-(4-aminobutyl) amine, and isomeric mixtures of dipropylene triamine and dibutylene triamine. Hexamethyl diamine, tetramethylene diamine, and especially 1,12-diaminododecane are preferred

The polymer gels of the present invention may have an extender added to the polymer during final processing. Suitable extenders include extender oils and low molecular weight compounds or components, such as the extenders including, but not limited to: naphthenic, aromatic, paraffinic, phthalic, and silicone oils A preferred extender for the present invention is a synthetic oil, such as di(tridecyl) phathalate oil The final polymer compositions can contain between about 5 and 95%, preferably about 10 and 50%, oil and are thermoreversible elastomers

A metal oxide filler is added to the polymer compositions of the present invention. By adding a metal oxide filler, the polymer compositions demonstrate significantly enhanced damping properties, as well as increased tensile strength while maintaining the softness of the compounds. Furthermore, the addition of metal oxide fillers to the polymer composition improves the electric sensibility of the gel, with at least a 12% change in dynamic modulus (G′), as measured at 1 Hz and 1% strain, being demonstrated when the gels were placed in a 1 kv/mm static electric field

Metal oxide fillers contemplated for use in the present invention include ME (II), ME (III), ME (IV) oxides, and mixtures thereof. Especially preferred metal oxides include ZnO, TiO₂, BaTiO₃, Fe₂O₃, and mixtures thereof The metal oxide fillers preferably have an average particle size of less than about 15 μm, more preferably less than about 10 μm.

Metal oxide fillers preferably comprise between about 0.1 and 40 wt % of the final composition, more preferably between about 1 and 35 wt %, and most preferably between about 2 and 30 wt %.

The fillers may be added to the polymer composition at temperatures between about room temperature and the decomposition temperature of the filler and/or polymer composition. The fillers may be added in a single charge or sequentially in multiple charges.

In addition, stabilizers, antioxidants, reinforcing agents, reinforcing resins, pigments, and fragrances are examples of additives which can also be utilized in the present invention.

The compositions of the present invention are favorably used in the manufacturing of any product in which the following properties are advantageous, a degree of softness, heat resistance, decent mechanical properties, elasticity, good adhesion, and/or high damping The compositions of the present invention can be used in many industry fields, in particular, in the fabrication of automotive parts, tire tread formulations, household electrical appliances, industrial machinery, precision instruments, transport machinery, constructions, engineering, medical instruments, and non-tread tire rubber formulations.

Representative examples of uses of the composition of the present invention are in the fabrication of damping materials and vibration restraining materials These uses involve connecting materials such as sealing materials, packing, gaskets, and grommets; supporting materials such as mounts, holders, and insulators, and cushion materials such as stoppers, cushions, and bumpers These materials are also used in equipment producing vibration or noise and household electrical appliances, such as in air-conditioners, laundry machines, refrigerators, electric fans, vacuums, dryers, printers, and ventilator fans. These materials are also suitable as impact absorbers in audio equipment and electronic or electrical equipment, sporting goods, and shoes

In the following, the present invention is described in more detail with reference to non-limiting examples. The following examples and table are presented for purposes of illustration only, and are not to be construed in a limiting sense

### EXAMPLES

### Example 1

(Centipede Polymer Formation)

To a 6 L kneader-extruder (MXE-6) equipped with sigma blades was added 1 252 kg Isoban-10™ poly(maleic anhydride-alt-isobutylene) (Kuraray Co, Tokyo, Japan), and 0.989 kg octylamine (BASF, Ludwigshafen, Germany) at 54° C. Mixing was started with a blade speed of 25 rpm and screw speed of 40 rpm for 5 minutes, and then the temperature of the mixer was adjusted to rise to 190° C. at a rate of about 3° C./minute Mixing was continued for 2 more hours isothermally at 190° C.

Then, 0 562 kg PO1015™ maleated polypropylene (Exxon Chemicals, Houston, Tex.) was added to the mixer. Mixing was continued for another 30 minutes, followed by addition of 23 g dodecane diamine (Aldrich). After 15 minutes, 1.397 kg di(tridecyl)phathalate (DTDP) oil (C P Hall Co) was added and the temperature was adjusted to 160° C. After another 2 hours, the final product was then extruded through a ¼ inch (0.63 cm) die.

The final product contained 33% DTDP oil and was a thermoreversible elastomer.

### Examples 2-10

(Preparation of Gel Compounds)

Various amounts of the product from the experiment of Example 1 were added to a Brabender mixer (˜55 g capacity) equipped with a roller blade. The mixer was initially set to 160° C. and 60 rpm and under nitrogen purging. After 3 minutes, a selective amount of filler and DTDP oil were added. The material was then further mixed at those conditions for 15 minutes, then, the agitation was turned off and the mixture was removed from the mixer

The formulations of samples 2 to 10 are shown in Table 1:

TABLE 1

| | | | | | |
|---|---|---|---|---|---|
| | Amount of | | Amount of | | |
| | sample 1 | | filler used | | Amount of |
| Example | used (gram) | Filler used | (gram) | Oil used | oil used |

| | | | | | |
|---|---|---|---|---|---|
| 2 | 25.0 | None | 0.0 | DTDP | 25 |
| 3 | 31.5 | ZnO | 5.0 | DTDP | 13.5 |
| 4 | 28.0 | ZnO | 10.0 | DTDP | 12.0 |
| 5 | 25.0 | ZnO | 3.0 | DTDP | 25.0 |
| 6 | 31.5 | TiO₂ | 5.0 | DTDP | 13.5 |
| 7 | 28.0 | TiO₂ | 10.0 | DTDP | 12.0 |
| 8 | 31.5 | BaTiO₃ | 5.0 | DTDP | 13.5 |
| 9 | 28.0 | BaTiO₃ | 10.0 | DTDP | 12.0 |
| 10 | 25.0 | TiO₂ | 3.0 | DTDP | 25.0 |

DTDP—Ditridecyl phathalate (from C.P. Hall Corporation, Chicago)
TiO₂—from Aldrich, Milwaukee (catalogue #22422-7, <5 μm)
BaTiO₃—from Aldrich, Milwaukee (catalogue #33884-2, <2 μm)

The products of Examples 2-10 were molded into sheets and cylinder buttons at ˜160° C. Ring samples were cut from these sheets for tensile measurements The detail of physical properties of the final materials are shown in Table 2

TABLE 2

| | | Tb | Eb | CS. | TanD | |
|---|---|---|---|---|---|---|
| Example | Filler | (kPa) | (%) | (145° C.) | (20° C.) | Shore A |
| 2 | none | 199 | 208 | 88.4 | 0.410 | 4 |
| 3 | ZnO | 1,143 | 219 | 54.3 | 0.351 | 24 |
| 4 | ZnO | 1,005 | 168 | 50.6 | 0.365 | 28 |
| S | ZnO | 441 | 217 | 58.5 | 0.287 | 10 |
| 6 | TiO₂ | 827 | 222 | 51.3 | 0.415 | 18 |
| 7 | TiO₂ | 882 | 229 | 40.4 | 0.42 1 | 23 |
| 8 | BaTiO₃ | 696 | 221 | 450 | 0418 | IS |
| 9 | BaTiO₃ | 634 | 186 | 437 | 0.411 | 18 |
| 10 | TiO₂ | 358 | 211 | 394 | 0298 | 6 |

As can be seen in the Table above, the products were soft, thermoreversible gels. These materials exhibited balanced tensile strength, damping properties, and thermostabilities. All materials shown in Table 2 were thermally recyclable above 160° C. and had a service temperature up to 145° C.

Although the invention has been described with reference to exemplary embodiments, various changes and modifications can be made without departing from the scope and spirit of the invention as defined in the appended claims

We claim:

1. A thermoreversible polymer gel composition having a Shore A hardness less than 30 comprising
a. a co-polymer having at least 1 block selected from a vinyl-substituted aromatic hydrocarbon, a R¹R²ethylene, and an alkyl vinyl ether, and at least one additional block containing maleimide contributed monomer units,
b. an extender,
c at least one metal oxide filler,
d a maleated polyalkylene, and
e. a grafting agent

2. The composition of claim 1 wherein said vinyl-substituted aromatic hydrocarbon is chosen from any one or combination of styrene, α-methylstyrene, 1-vinylnaphthalene, 2-vinyl-naphthalene, 1-α-methylvinylnaphthalene, 2-α-methyl vinylnaphthalene, as well as alkyl, cycloalkyl, aryl, alkaryl, and aralkyl derivatives thereof, in which the total number of carbon atoms in the combined hydrocarbon is generally not greater than 18, as well as any di- or tri-vinyl-substituted aromatic hydrocarbons

3. The composition of claim 2 wherein said vinyl-substituted aromatic hydrocarbon is styrene

4. The composition of claim 1 wherein said R¹R²ethylene is one or more of ethylene, propylene, butylene, isobutylene, pentene, hexene, and heptene

5. The composition of claim 4 wherein said R¹R²ethylene is isobutylene

6. The composition of claim 1 wherein said alkyl vinyl ether is one or more of methyl vinyl ether, ethyl vinyl ether, propyl vinyl ether, butyl vinyl ether, pentyl vinyl ether, hexyl vinyl ether, and an alkyl vinyl ether with up to 20 carbon atoms in the alkyl substituent.

7. The composition of claim 1 wherein said R¹ and R² groups of the R¹R² ethylene and the alkyl groups of said alkyl vinyl ether are independently chosen from one or more of methyl, ethyl, propyl, isopropyl, butyl, isobutyl, pentyl, isopentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, cyclopropyl, 2,2, -dimethylcyclopropyl, cyclopentyl, cyclohexyl, methoxymethyl, methoxypropyl, methoxybutyl, methoxypentyl, methoxyhexyl, methoxyheptyl, methoxyoctyl, methoxynonyl, methoxydecyl, ethoxymethyl, ethoxyethyl, ethoxypropyl, ethoxybutyl, ethoxypentyl, ethoxyhexyl, ethoxyheptyl, ethoxyoctyl, ethoxynonyl, ethoxydecyl, propoxymethyl, propoxyethyl, propoxypropyl, propoxybutyl, propoxypentyl, propoxyhexyl, propoxyheptyl, propoxyoctyl, propoxynonyl, propoxydecyl, butoxybutoxymethyl, butoxyethyl, butoxypropyl, butoxybutyl, butoxypentyl, butoxyhexyl, butoxyheptyl, butoxyoctyl, butoxynonyl, butoxydecyl, pentyloxymethyl, pentyloxyethyl, pentyloxpropyl, pentyloxybutyl, pentyloxypentyl, pentyloxyhexyl, pentyloxyoctyl, pentyloxynonyl, pentyloxydecyl, hexyloxymethyl, hexyloxyethyl, hexyloxypropyl, hexyloxybutyl, hexyloxypentyl, hexyloxyhexyl, hexyloxyheptyl, hexyloxyoctyl, hexyloxynonyl, hexyloxydecyl, heptyloxymethyl, heptyloxyethyl, heptyloxypropyl, heptyloxybutyl, hexyloxypentyl, heptyloxyhexyl, heptyloxyheptyl, heptyloxyoctyl, heptyloxynonyl, heptyloxydecyl, octyloxymethyl, octyloxyethyl, octyloxypropyl, octyloxybutyl, octyloxypentyl, octyloxyhexyl, octyloxyheptyl, octyloxynonyl, octyloxyoctyl, decyloxymethyl, decyloxyethyl, decyloxypropyl, decyloxybutyl, decyloxypentyl, decyloxyhexyl, decyloxyheptyl, 1-methylethyl, 1-methylpropyl, 1-methylbutyl, 1-methylpentyl, 1-methythexyl, 1-methylheptyl, 1-methyloctyl, 1-methylnonyl, 1-methyldecyl, 2-methylpropyl, 2-methylbutyl, 2-methylpentyl, 2-methylhexyl, 2-methylheptyl, 2-methyloctyl, 2,3-dimethylbutyl, 2,3,3-trimethylbutyl, 3-methylpentyl, 2,3-dimethylpentyl, 2,4-dimethylpentyl, 2,3,3,4-tetramethylpentyl, 3-methylhexyl, 2,5-dimethylhexyl, and the like

8. The composition of claim 1 wherein said maleimide is the reaction product of maleic anhydride and a mono-primary amine.

9. The composition of claim 8 wherein said mono-primary amine is octyl amine

10. The composition of claim 1 wherein said extender comprises at least about 10% of the composition

11. The composition of claim 10 wherein said extender is a di(tridecyl) phathalate oil

12. The composition of claim 1 wherein the monomer from which the alkylene moiety of said maleated polyalkylene is derived from at least one of ethylene and propylene

13. The composition of claim 1 wherein said grafting agent comprises at least one of primary amines, secondary amines, carboxyl, formyl, and hydroxyl.

14. The composition of claim 1 wherein said grafting agent is a diamine

15. The composition of claim 1 wherein said metal oxide filler comprises at least one of ZnO, TiO₂, BaTiO₃, Fe₂O₃, and mixtures thereof.

16. The composition of claim 1 wherein said metal oxide filler has a particle size less than about 15 μm

17. The composition of claim 1 wherein said metal oxide filler comprises between about 0.1 and 40 wt % of the final composition.

18. A method for forming a thermoreversible polymer gel composition having a Shore A hardness less than 30 and a service temperature up to about 145° C. comprising mixing together:
a a copolymer having at least 1 block selected from a vinyl-substituted aromatic hydrocarbon, a R¹R²ethylene, an alkyl vinyl ether, and at least one additional block containing maleimide contributed monomer units,
b an extender,
c. at least one metal oxide filler,
d. a maleated polyalkylene, and
e. a grafting agent

19. A method of claim 18 wherein said metal oxide filler comprises at least one of ZnO, TiO₂, BaTiO₃, Fe₂O₃, and mixtures thereof.

20. The method of claims 18 wherein said metal oxide filler comprises between about 0 1 and 40 wt % of the final composition
